(19) United States
(12) Patent Application Publication
(10) Pub. No.: US 2006/0112169 A1
(43) Pub. Date: May 25, 2006

(54) Communication system and method of multimedia messaging

(76) Inventors: Maarten Peter Bodlaender, Eindhoven (NL); Henricus Xavier Willems, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/543,953

(22) PCT Filed: Jan. 14, 2004
(86) PCT No.: PCT/IB04/50020

§ 371 Date: Aug. 1, 2005

(30) Foreign Application Priority Data
Feb. 4, 2003 (EP) 03100219.9

(51) Int. Cl. G06F 15/16

(52) U.S. Cl. 709/217

(57) ABSTRACT

The invention relates to multi media messaging for communication units lacking multi media capability. A communication system (100) comprises a first communication unit (101) wherein a text based message is generated comprising a pointer, such as a URL, to a multi media clip on a multi media server (115). The message is communicated to a second communication unit (109), which comprises an extraction processor (111) that extracts the pointer and feeds it to a retrieve processor (113). The retrieve processor (113) retrieves the multi media clip from the multi media server (115) addressed by the URL. A presentation processor (117) subsequently presents the multi media clip to a user. The invention is particularly suitable for multi media messaging from cellular communication units having only capability of text based messaging.

The invention relates to a communication system and method of multi media messaging therefor and in particular to a system and method of multi media messaging between a first and a second communication unit.

In the last decade, text based communication and message exchange has become increasingly prevalent and is now one of the main communication forms for distance communication.

For example, the use of email has grown explosively and is now one of the preferred communication forms for business communication. Typically, email is implemented by use of a computer having a network connection to the Internet The text based email is communicated as one or more data packets through the Internet and may be temporarily stored on email servers.

Initially, email was almost exclusively used for text based messaging but as it has become more widespread, the standard text message now frequently has file attachments. These files may be text documents but may also be multi media files such as video clips or audio clips. When receiving such attachments, the recipient may open the file in an associated program and play the multi media file. This requires manual interaction by the recipient and transfers control over the presentation characteristics from the transmitter to the receiver. Also, it requires that both the receiving and transmitting terminal are multi media capable. In addition, the bandwidth required for multi media files is significantly higher than for text based communication, and therefore the load on the network and the associated download or upload times for the message increases significantly. This is particularly problematic for Internet enabled wireless mobile devices such as wireless Personal Digital Assistants (PDAs) as the available over the air bandwidth may be limited and costly and as the functionality and computational and memory resource typically is limited in comparison to computers.

In the field of mobile communications, text based communication has become common with the advent of the Short Messaging Service (SMS). SMS is based on text entries made and displayed on mobile phones having small displays and keyboards. However, with the introduction of new capability in mobile phones and the advent of new packet based communication standards, a need for more advanced multi media based message communication has been identified. For example, mobile phones with large colour displays and built in cameras are currently emerging for communication standards such as the General Packet Radio Service (GPRS) and 3^{rd} Generation standards. Accordingly, the industry has standardised a new messaging service called Multi Media Service (MMS). This messaging service allows a user to include pictures, sound and video clips in a message. The combined message is then sent from the originating mobile station through the fixed network to the receiving mobile station, which then displays the message.

However, this requires the full message to be communicated, which is frequently many times larger than a corresponding text message. For mobile communication systems, the over the air bandwidth is significantly limited and therefore the cost of communicating MMS messages is substantially higher than SMS messages. Also, MMS requires that both the transmitting and receiving end are MMS capable and thus prevents that most of the mobile phones currently on the market can be used for multi media messaging. Furthermore, if a message is communicated to a computer rather than to another mobile station, the message is limited by the capabilities of the transmitting mobile station rather than the receiving computer.

Hence, an improved system for multi media messaging would be advantageous and in particular a system allowing for a reduced bandwidth requirement and allowing multi media communication from communication units having limited or no multi media functionality.

Accordingly, the Invention seeks to mitigate, alleviate or eliminate one or more of the above mentioned disadvantages singly or in any combination.

According to a first aspect of the invention, there is provided a method of multi media messaging comprising the steps of: in a first communication unit generating in response to a user input a text based message; comprising a pointer to a multi media clip on a multi media server; communicating the text based message to a second communication unit; and in the second communication unit: extracting the pointer from the text based message, retrieving the multi media clip from the multi media server in response to the pointer, and presenting the multi media clip to a user.

Hence, a multi media message may automatically be generated by the receiving communication unit automatically retrieving a pointer from a text message, retrieving an associated multi media clip and presenting it to the user. The presented multi media clip may specifically be indistinguishable from a standard multi media message from a multi media enabled transmitting communication unit.

Accordingly, the invention allows for multi media messages to be communicated from communication units having no multi media capabilities. Rather a simple text message may be used to cause a multi media message to be presented to the user of the receiving communication unit. The system requires no manual interaction from the user of the second communication unit Furthermore, the presentation characteristics may be determined by the transmitting user. Furthermore, the bandwidth required for communication of the message may be significantly reduced. This is particularly useful if the first communication unit is associated with a more stringent bandwidth restriction than the second communication unit, such as for example when communicating from a mobile phone to a computer. In addition, the invention allows for the multi media message to be restricted only by the capability of the receiving communication unit.

According to a feature of the invention, the text based message further comprises a text message part and the method further comprises the steps of in the second communication unit separating the text message part and presenting the text message part to the user. The text may be displayed simultaneously as the multi media clip, for example by overlaying a video clip with the text message. This allows for multi media clip to be used with text messages and is particularly useful for including specific information with a general multi media clip.

According to a different feature of the invention, the method further comprises the step of synchronising the presentation of the text message part and the presentation of the multi media clip. For example the playback time or speed of a text message may be synchronised with the speed or duration of the multi media clip. This allows for a coordinated and harmonised presentation of the text message and the multi media clip.

According to a different feature of the invention, the step of presenting the text message part comprises presenting the text message part as synthesized speech. This further enhances the presentation possibilities and does not require a recipient to watch the display in order to receive the text message information. The text based message may for example be converted to a speech signal and presented together with a multi media clip, such as a music clip.

According to a different feature of the invention, the text based message comprises text based presentation commands and the method further comprises the step of in the second communication unit setting at least one characteristic of the presentation of the multi media clip in response to the text based presentation command. This enhances the possibilities of the transmitting communication unit to control the presentation characteristics at the receiving communication unit

According to a different feature of the invention, the communication of the text based message is through a communication channel having a bandwidth insufficient to support multi media messaging. The invention thus provides a method of multi media messaging through a communication channel which has insufficient bandwidth to support communication of multi media clips. The communication channel may be insufficient to support communication of multi media clips, if the bandwidth limitation results in for example an unacceptable or unreasonable communication delay, duration or cost. The communication channel may specifically be a wireless communication channel such as a communication channel of a cellular communication system.

According to a different feature of the invention, the first communication unit lacks functionality for supporting multi media messaging. The invention thus provides a method of multi media messaging for a communication unit that does not have any or only insufficient functionality for generating, handling and/or communicating multi media clips.

According to a different feature of the invention, the text based message is an email message. Accordingly, the invention allows for low bandwidth multi media messaging from text based email.

According to a different feature of the invention, the first communication unit is a subscriber unit for a cellular communication system, and preferably the text based message is a Short Messaging Service (SMS) message. The invention thus allows for multi media messaging from a subscriber unit of a cellular communication unit lacking functionality and or bandwidth for supporting generation and/or communication of multi media clips.

According to a different feature of the invention, the multi media server is part of the second communication unit. This allows for fast access to the multi media server and thus low complexity and fast retrieval and presentation of the multi media clip.

According to a different feature of the invention, the multi media server is external to the second communication unit and the step of the second communication unit retrieving the multi media clip comprises accessing the multi media server through an external communication link. This allows for central multi media servers to be shared between different communication links. The multi media server may for example be a public multi media server.

According to a different feature of the invention, the external communication link is formed in a network. This allows for an easy implementation wherein a plurality of communication units may access the same multi media server.

According to a different feature of the invention, the network is the Internet This permits easy access to a multi media server and facilitates implementation of the multi media server as this may be centrally created but easily accessible by all communication units having Internet access.

According to a different feature of the invention, the pointer comprises a Uniform Resource Locator (URL) pointing to a multi media location. This allows for a suitable, user friendly and Internet compatible reference to the multi media clip.

According to a different feature of the invention, the pointer comprises an abbreviated URL indication and the method further comprises the step of, in the second communication unit, determining a non-abbreviated URL from the abbreviated URL indication. This allows for abbreviated URLs to be used in the first communication unit thereby facilitating the text entry required for referencing a multi media clip.

According to a second aspect of the invention, there is provided a communication system comprising: a first communication unit comprising means for generating a text based message in response to a user input, the text based message comprising a pointer to a multi media clip on a multi media server, means for communicating the text based message to a second communication unit; and a second communication unit comprising: means for extracting the pointer from the text based message, means for retrieving the multi media clip from the multi media server in response to the pointer, and means for presenting the multi media clip to a user.

These and other aspects, features and advantages of the invention will be apparent from and elucidated with reference to the embodiment(s) described hereinafter.

An embodiment of the invention will be described, by way of example only, with reference to the drawings, in which

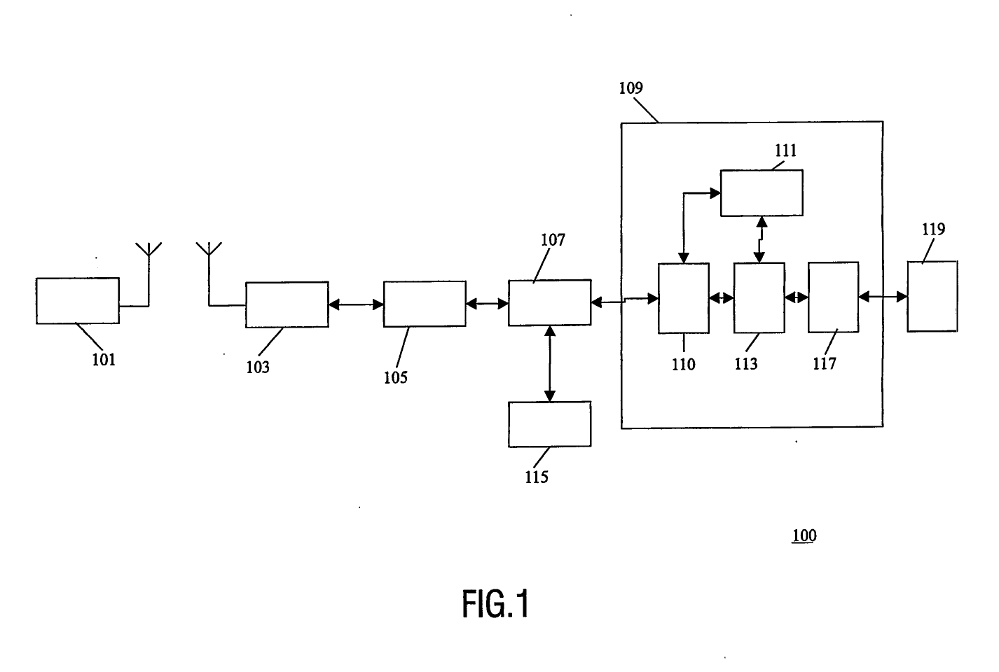

FIG. 1 is an illustration of a communication system in accordance with an embodiment of the invention; and

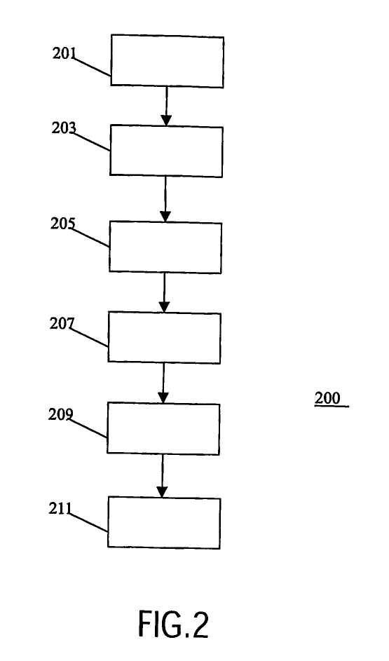

FIG. 2 shows a flowchart of a method of multi media messaging in accordance with an embodiment of the invention.

The following description focuses on an embodiment of the invention applicable to multi media messaging using a cellular communication system and in particular to multi media messaging from a cellular communication unit using text based messaging. However, it will be appreciated that the invention is not limited to this application but may be applied to many other applications including for example other wireless communication systems, network based communication systems and the Internet. Although the description focuses on SMS text based messaging, the invention is equally applicable to other text based messages including for example email.

FIG. 1 is an illustration of a communication system 100 in accordance with an embodiment of the invention.

The communication system 100 comprises a first communication unit 101 which in the specific example described is a Global System for Mobile communication (GSM) communication unit capable of transmitting text based messages in accordance with the Short Messaging Service (SMS) standard. In the described example, the first communication unit 101 is only capable of generating and transmitting SMS messages and is not capable of generating and communicating multi media messages. The first communication unit 101 is operable to communicate over a radio channel with a GSM fixed network 103. The first communication unit 101 is thus operable to generate a text based message in the form of an SMS message and to communicate that to the fixed network 103. In accordance with an embodiment of the invention, the SMS message comprises a pointer to a multi media clip on a multi media server.

The fixed network 103 is operable to communicate with GSM communication units over the air in accordance with the GSM standard. The fixed network is furthermore operable to interface to other communication systems, such as the public telephone system and the Internet. It will be apparent to the person skilled in the art, that the fixed network 103 comprises base stations, base station controllers, mobile switching centres and other equipment required and desired for operation of a conventional GSM cellular communication system.

The fixed network 103 is coupled to a gateway 105 which is coupled to the Internet 107. The gateway 105 is operable to perform the necessary operations in order to interface the GSM cellular communication system and the Internet including for example functionality for packetising data in accordance with the TCP/IP data protocol. Thus the fixed network 103 is operable to communicate the SMS message from the first communication unit 101 through the gateway 105 to the Internet 107.

The Internet is coupled to the second communication unit 109. In the specific example, the second communication unit 109 is a personal computer. In other embodiments, the second communication unit 109 may be a wireless device such as a wirelessly connected Personal Digital Assistant (PDA) or a multi media capable cellular communication unit. In this case, the second communication unit 109 may be communicating with the fixed network 103, and may specifically access the Internet 107 through the fixed network 103. The Internet 107 is specifically capable of communicating the SMS message from the gateway 105 to the second communication unit 109.

FIG. 1 illustrates some functional modules of the second communication unit 109. For clarity and brevity, only functional modules required for the description of the preferred embodiment are shown, and it will be apparent to the person skilled in the art, that the second communication unit 109 may comprise other functional modules in addition to those shown.

The second communication unit 109 comprises an interface 110, which is operable to interface with the Internet 107 and thus to receive and transmit data packets in accordance with the TCP/IP data protocol. The interface 110 may for example be a standard telephone modem or a cable modem. The interface 110 is specifically operable to receive the SMS based text message from the first communication unit 101.

The interface 110 is coupled to an extraction processor 11. The extraction processor 111 is operable to extract the pointer from the received SMS message. The extraction processor 111 is further coupled to a retrieve processor 113 which is operable to retrieve the multi media clip from the multi media server 115 in response to the pointer. In the described embodiment the multi media server 115 is an Internet based server, which is accessed by the retrieve processor 113 through the interface 110 and the Internet 107.

The retrieve processor 113 is coupled to a presentation processor 117 which is operable to present the multi media clip to a user. In the described embodiment, the presentation processor 117 is coupled to a display 119 which specifically is a monitor.

FIG. 2 shows a flowchart of a method 200 of multi media messaging in accordance with an embodiment of the invention. The method 200 is applicable to the communication system 100 of FIG. 1 and will be described with reference to this.

The method initiates in step 201 wherein a text based message is generated in the first communication unit 101. Specifically, an SMS message is generated by the user using the keyboard on the first communication unit 101 to enter text. The SMS message comprises a pointer to a multi media clip which is not available in the first communication unit 101. Rather the multi media clip resides on a remote multi media server 115. Accordingly, the first communication unit 101 need not process or communicate the actual multi media clip but only need to communicate the SMS message which references the multi media clip. This requires substantially less communication bandwidth and the approach may thus be used advantageously not only when the first communication unit 101 has no or insufficient multi media capabilities, but also when a bandwidth associated with the first communication unit 101 is so limited that it renders multi media communication impractical. For instance, the radio communication link between the first communication unit 101 and the fixed network 103 may have a low bandwidth which is not suitable for multi media messaging. For example, the bandwidth of a GSM channel tends to be too limited to be suited for multi media communication of large size multi media files, such as long real-time video clips at high quality and resolution.

In the preferred embodiment, the pointer to the multi media clip is preferable in the form of text specifying a URL (Uniform Resource Locator) corresponding to an Internet address from where the multi media clip can be retrieved. Furthermore, in the preferred embodiment, the generated SMS message comprises both a pointer to a multi media clip and a text message part. The text message is intended to be presented to the user of the second communication unit 109 whereas the pointer is not intended to be presented, but rather is used by the second communication unit 109 to present a multi media clip.

As a specific example, a user of the first communication unit 101 may generate an SMS message by keying in the following text:

“www.mysongs.com/user22323/lovesong.mp3

Hi Marjolein, I love you, Jasper”

Hence, the SMS message points to an Internet address wherein the user in advance has stored the MP3 file “lovesong.mp3”. In addition, the second line comprises a message which is to be presented un-amended to the user of the second communication unit 109.

Step 201 is followed by step 203 wherein the SMS message is transmitted from the first communication unit 101 to the fixed network 103 and from there through the gateway 105 and the Internet 107 to the second communication unit 109. In this step only the SMS message is communicated. As the SMS message requires very little data to be communicated (typically a few hundred bytes) the loading on the cellular communication system is very limited. In contrast, an MP3 file is typically several Mbytes, and the air interface resource consumption of communication the SMS message is thus typically more than a thousand times lower than a communication of the corresponding MP3 file.

Step 203 is followed by step 205 wherein the second communication unit 109 receives the SMS message through the interface 110.

Step 205 is followed by step 207 wherein the SMS message is fed from the interface 110 to the extraction processor 111. In the preferred embodiment, the extraction processor 111 further determines if the SMS message comprises a pointer to a multi media clip on a multi media server 115 and if so, it proceeds to extract the pointer.

In one embodiment, the extraction processor 111 searches the SMS message for text matching the specifications for a URL reference, and if detected, it extracts this text. For example, the extraction processor 111 may search the SMS message for the text “www.”. If the text is detected, it will extract the following text until a space is encountered. In a simpler embodiment, a protocol wherein the URL is entered as the first line of an SMS message may be used, in which case the extraction processor 111 extracts the first line as the pointer, if the SMS message starts with “www.”. If the extraction processor 11 does not detect the text “www”, it determines that no pointer is included in the text, and the received SMS message is presented to the user as for a standard SMS message, as is well known to the person skilled in the art.

Step 207 is followed by step 209 wherein the pointer is fed from the extraction processor 111 to the retrieve processor 113. The retrieve processor 113 proceeds to retrieve the multi media clip from the multi media server 115 in response to the pointer. In the preferred embodiment, the retrieve processor 113 controls the interface to access URL extracted from the message and to download the file located there. The multi media clip is thus retrieved by downloading it from an external multi media server 115 through a network which in this case is the Internet. Although this step requires the large MP3 file to be downloaded, this may be done over the Internet and may thus use high data rate connections. Specifically, this download requires no communication to be performed over the cellular communication system, and thus does not use the scarce and expensive radio resource.

Step 209 is followed by step 211 wherein the downloaded multi media clip and the text message part of the SMS message is fed to the presentation processor 117. The presentation processor 117 thus receives the MP3 file lovesong.MP3 and the text “Hi Marjolein, I love you, Jasper”. The presentation processor 117 then proceeds to play the multi media clip and simultaneously display the message on the display 119. Any suitable known method for presenting a multi media clip or text message to a user may be used without detracting from the invention.

It will thus be appreciated that the described embodiment enables and facilitates multi media messaging for communication units which do not have the required capability for conventional multi media messaging or where such a communication would result in an undesired, unacceptable or unavailable bandwidth requirement.

In some embodiments, the step 211 of presenting the multi media clip and the text message comprises synchronising presentation of the text message part and the presentation of the multi media clip. Thus, in one such embodiment, the playback speed of the text and or the multi media clip may be adjusted such that the playing times are matched. In other embodiments, synchronisation may for example be achieved by repeating the text message for the duration of the multi media clip.

In some embodiments, the text message may be converted to another format before being presented to the user. Specifically, the step 211 of presenting the multi media clip and the text message may comprise converting the text to synthesized speech and overlaying it on an audio clip. In the specific example, the words “I love you” may thus be read out while the music in the file lovesong.MP3 is played.

In some embodiments, the text based message may comprise text based presentation commands. For example, text commands may be used to control the volume, quality, speed or time of the play back of the multi media clip. For example, the SMS message may comprise the command “@volume=max” indicating that the multi media clip should be played back at the maximum volume. The character “@” is in this example used to indicate a command. In these embodiments, the second communication unit 109 comprises functionality for retrieving these commands and modifying the presentation characteristics accordingly. In addition, the second communication unit 109 may comprise functionality for limiting such rendering commands for example by defining an acceptable range of values for each presentation parameter.

In some embodiments, the pointer may not be a full URL but rather may be an abbreviated URL. Upon receiving an abbreviated URL, the second communication unit 109 completes the URL, for example by comparing the received URL indication to a local lookup table comprising a number of predefined URLs.

In some embodiments, the URL may not refer to a specific multi media clip but to a location from where a multi media clip can be retrieved. The actual multi media clip retrieved may be modified by a third party. For example, a URL of “www.1top40.com” may refer to a location where the current number 1 of a top40 hitlist is stored. The actual multi media clip that will be retrieved will thus change as the current number 1 changes.

In the described embodiment, the multi media server was an external multi media server accessed through a network. However, it will be apparent that any suitable physical and logical location of the multi media server may be used, and specifically that the multi media server may be part of the second communication unit. For example, a user of the second communication unit may maintain a local list of multi media clip arranged such that they can be referenced by a text message. Upon receiving the text message, the second communication unit will determine if it comprises a reference to a multi media clip locally stored, and if so, will present the corresponding multi media clip. Preferably, a number of possible pointer values are predefined and known to the user of the first communication unit, while the multi media clip associated with each predetermined pointer may be selected individually by the user of the second communication unit without the first user knowing. Hence, the user of the first communication unit 101 may know that a reference to “your.favourite.lovesong” will cause a love song stored in the second communication unit 109 to be played but may not know what the actual song is.

Although the above description has focussed on an application for SMS messaging, it will be apparent that any suitable text based messaging may be used, and that the invention is not limited to wireless or mobile communication. Specifically, the invention may be applied to text messaging based on email.

Furthermore, any person skilled in the art will appreciate that not necessarily the receiver of the message has to be at a fixed location and neither has the sender to be mobile, as bandwidth of mobile connections increases and not all fixed internet (or other communication network) connections provide broadband access to a communication network. As is apparent from the description, however, the deployment of the invention in a situation with a mobile sender is advantageous.

Besides that, it will be apparent to a person skilled in the art that the concept ‘multi media clip’ comprises objects like audio-visual datastreams like files with mpeg encoded material comprising either audio or visual data or both, but also still images and that this concept is not limited to this.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

In summary, the invention relates to multi media messaging for communication units lacking multi media capability. A communication system (100) comprises a first communication unit (101) wherein a text based message is generated comprising a pointer, such as a URL, to a multi media clip on a multi media server (115). The message is communicated to a second communication unit (109), which comprises an extraction processor (111) that extracts the pointer and feeds it to a retrieve processor (113). The retrieve processor (113) retrieves the multi media clip from the multi media server (115) addressed by the URL. A presentation processor (117) subsequently presents the multi media clip to a user. The invention is particularly suitable for multi media messaging from cellular communication units having only capability of text based messaging.

1. A method (200) of multi media messaging comprising the steps of:
in a first communication unit (101) generating (201) in response to a user input a text based message; comprising a pointer to a multi media clip on a multi media server (115);
communicating (203, 205) the text based message to a second communication unit (109); and
in the second communication unit (109)
extracting (207) the pointer from the text based message,
retrieving (209) the multi media clip from the multi media server (115) in response to the pointer, and
presenting (211) the multi media clip to a user.

2. A method as claimed in claim 1 wherein the text based message further comprises a text message part and further comprising the steps of in the second communication unit separating the text message part and presenting the text message part to the user.

3. A method as claimed in claim 2 further comprising the step of synchronising the presentation of the text message part and the presentation of the multi media clip.

4. A method as claimed in claim 2 wherein the step of presenting (211) the text message part comprises presenting the text message part as synthesized speech.

5. A method as claimed in claim 1 wherein the text based message comprise text based presentation commands and further comprising the step of in the second communication unit (109) setting at least one characteristic of the presentation of the multi media clip in response to the text based presentation command.

6. A method as claimed in claim 1 wherein the communication (203, 205) of the text based message is through a communication channel having a bandwidth insufficient to support multi media messaging.

7. A method as claimed in claim 1 wherein the first communication unit (101) lacks functionality for supporting multi media messaging.

8. A method as claimed in claim 1 wherein the text based message is an email message.

9. A method as claimed in claim 1 wherein the first communication unit (101) is a subscriber unit for a cellular communication system.

10. A method as claimed in claim 9 wherein the text based message is a Short Messaging Service (SMS) message.

11. A method as claimed in claim 1 wherein the multi media server (115) is part of the second communication unit (109).

12. A method as claimed in claim 1 wherein the multi media server (115) is external to the second communication unit (109) and the step of the second communication unit (109) retrieving multi media clip comprises accessing the multi media server (115) through an external communication link.

13. A method as claimed in claim 12 wherein the external communication link is formed in a network.

14. A method as claimed in claim 13 wherein the network is the Internet (107).

15. A method as claimed in claim 14 wherein the pointer comprises a Uniform Resource Locator pointing to a multi media location.

16. A method as claimed in claim 15 wherein the pointer comprises an abbreviated URL indication and further comprising the step of in the second communication unit (109) determining a non-abbreviated URL from the abbreviated URL indication.

17. A computer program enabling the carrying out of a method according to claim 1.

18. A record carrier comprising a computer program as claimed in claim 17.

19. A communication system (100) comprising:
a first communication unit (101) comprising means for generating a text based message in response to a user input, the text based message comprising a pointer to a multi media clip on a multi media server (115);
means for communicating the text based message to a second communication unit (109); and
a second communication unit (109) comprising:
means (111) for extracting the pointer from the text based message,
means (113) for retrieving the multi media clip from the multi media server (115) in response to the pointer, and
means (117) for presenting the multi media clip to a user.
